(19) United States
(12) Patent Application Publication
(10) Pub. No.: US 2007/0207819 A1
(43) Pub. Date: Sep. 6, 2007

(54) IM mobile phone for desktop

(75) Inventor: Richard Redpath, Cary, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/365,359

(22) Filed: Mar. 1, 2006

(51) Int. Cl. H04Q 7/20

(52) U.S. Cl. 455/466; 709/206

(57) ABSTRACT

A method, system, and program product for providing an instant messaging (IM) mobile phone interface to a desktop interface is disclosed. The method includes providing an IM communication between at least one desktop and one mobile device and then using an IM application, for example a MIDlet, from the mobile device on the desktop.

### BACKGROUND OF THE INVENTION

1. Field of the Invention

The present invention relates generally to electronic communication between a desktop user and a mobile device user. More specifically, the present invention provides a method, system, and computer program product for improved instant messaging (IM) communication between heterogeneous network interfaces.

2. Background Art

In the field of electronic network communications, Internet Service Providers (ISP) such as AOL® or ICQ®) provide an IM, or “Chat”, communication interface for their users to talk to each other over the Internet. ICQ boasts over 2.5 million users that use their Chat facility. There are many ISP's which are competing in this area including Yahoo!®'s Messenger and Microsoft®'s Message Service, MSN®. Microsoft and MSN are trademarks of Microsoft Corporation in the United States, other countries, or both.

Mobile phone devices are using Chat communication via Simple Message Systems (SMS). There exists a problem with a mobile phone device connecting to someone on a desktop device in that the constraints of the mobile device are not evident to the user of the desktop device, and therefore discipline is needed for the desktop user to perform IM actions when communicating to the mobile device. For example, the size of the text that will fit on the mobile device screen or sending of images. A mobile device only has a numeric keyboard for input, while a desktop device has a full keyboard (e.g., full alphabet, numerals, symbols, etc.). Another example of the distinction between devices is that the desktop has a “cut & paste” capability, while most the mobile devices do not or are more ergonomically awkward. Prior art in resolving this problem is limited in that the user (i.e., desktop) can perform the desktop action but no results will appear at the receiver interface (i.e., mobile device) hence confusion and realization, possibly only later on, of the limitation(s).

In view of the foregoing, there exists a need for a method, system, and program product for providing for improved instant messaging (IM) communication between heterogeneous network interfaces.

### SUMMARY OF THE INVENTION

In general, the present invention provides a method, system and program product for providing an instant messaging (IM) mobile phone interface to a desktop interface.

A first aspect of the present invention provides a method of providing an instant messaging (IM) mobile phone interface to a desktop interface, comprising the steps of: providing an IM communication between a desktop and a mobile device; and using a mobile device IM application on the desktop.

A second aspect of the present invention provides a system for providing an instant messaging (IM) mobile phone interface to a desktop interface comprising: a system for IM communication between a desktop and a mobile device; and a system for using a mobile device IM application on the desktop.

A third aspect of the present invention provides program product stored on a computer readable medium for providing an instant messaging (IM) mobile phone interface to a desktop interface, the computer readable medium comprising program code configured to: provide an IM communication between a desktop and a mobile device; and use a mobile device IM application on the desktop.

A fourth aspect of the present invention provides deploying an application for providing an instant messaging (IM) mobile phone interface to a desktop interface, comprising: providing a computer infrastructure being operable to: provide an IM communication between a desktop and a mobile device; and use a mobile device IM application on the desktop.

A fifth aspect of the present invention provides computer software embodied in a propagated signal for providing an instant messaging (IM) mobile phone interface to a desktop interface, the computer software comprising instructions to cause a computer system to perform the following functions: providing an IM communication between a desktop and a mobile device; and using a mobile device IM application on the desktop.

Therefore, the present invention provides a method, system, and a computer program product for providing an instant messaging (IM) mobile phone interface to a desktop interface.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a pictorial of a network environment, in accordance with an embodiment of the present invention.

FIG. 2A depicts a schematic view of network environment, in accordance with a first embodiment of the present invention.

FIG. 2B depicts a schematic view of a network environment, in accordance with a second embodiment of the present invention.

FIG. 3 depicts a desktop user interface employing an instant messaging (IM) mobile phone for desktop interface, in accordance with an embodiment of the present invention.

FIGS. 4A and 4B depict various IM mobile device for desktop interfaces, in accordance with embodiments of the present invention.

FIG. 5 depicts a flowchart of a method for providing an instant messaging (IM) mobile phone interface to a desktop interface, in accordance with an embodiment of the present invention.

FIG. 6 depicts a computerized system for providing an instant messaging (IM) mobile phone interface to a desktop interface in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

As indicated above, the present invention provides a method, system and program product for providing an instant messaging (IM) mobile phone interface to a desktop interface.

Embodiments of the present invention provide an IM, or Chat, interface that presents the capability of the mobile devices that are connected in a Chat session to the desktop interface. In some embodiments, the Chat interface will reuse the code of the mobile application on a desktop computer that is also used by the mobile device in the Chat session. An embodiment includes providing a means for reusing the original application code of the mobile device on the desktop computer thereby providing the capability information to the desktop user for a Chat interface that is appropriate for user interactions.

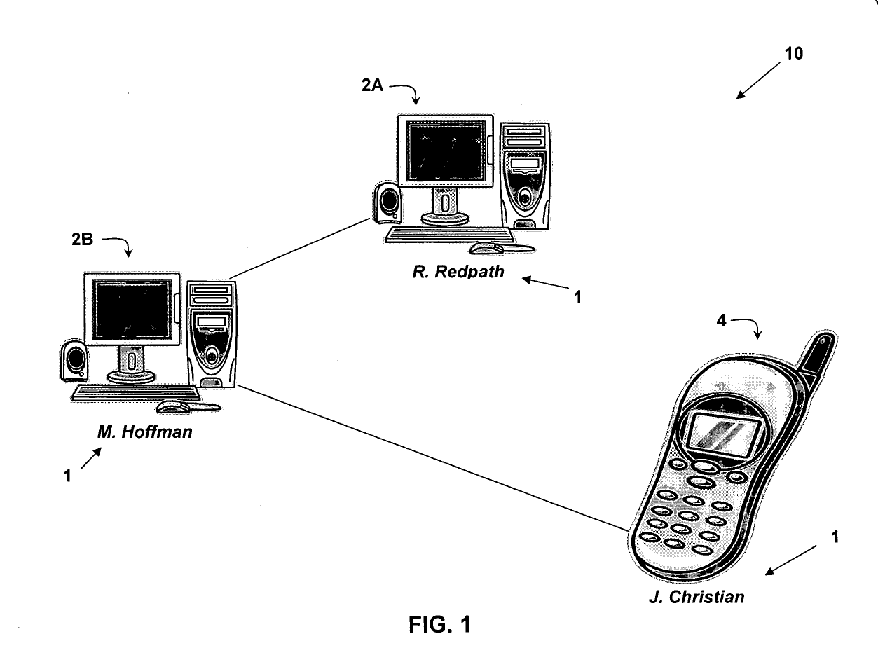

FIG. 1 shows a typical network of communication, denoted by a 10, between several people, or users 1, that are employing various devices to communicate electronically with each other in an Internet IM, or “Chat”, environment. The users 1 may use the same and/or different types of devices to communicate over the network 10. In the embodiment shown, three users 1, “R. Redpath”, “M. Hoffman”, and “J. Christian” are in communication with each other, via their respective devices, which in the embodiment shown are a desktop 2A, another desktop 2B, and a mobile phone 4, respectively for users 1 “Redpath”, “Hoffman”, and “Christian”. As discussed above, and as this present invention addresses, certain shortcomings are evident when at least two users 1 have heterogeneous devices 2, 4 (e.g., a desktop computer and a mobile phone, etc.). These shortcomings are exacerbated when these users 1 are communicating via IM application(s), alternatively called “IM”, “Chat sessions” or “Chatting”.

Desktop 2 and mobile phone 4 are used herein not as terms of limitation but of general description and are meant to connote that desktop 2 may include various personal computer-type devices including a stationary personal computer (PC), a lap-top PC, and other similar device now known or later developed. That is desktop 2 includes devices that, on whole, may have larger display areas and/or more keys and keystroke functionality than the mobile phone 4. Similarly, mobile phone 4, as used herein, is not limited to only cell phones, but includes devices such as a personal digital assistant (PDA), palm top computer, and similar devices now known or later developed. Mobile phone 4 includes devices that, on whole, may have a smaller display area and/or less keys and keystroke functionality than the desktop 2. Thus, as used herein, conceivably the term mobile phone 4 and desktop 2 may, in some embodiments, include a situation where both devices, in the view of a layperson, are from the same generic category or group of communication devices. The difference being that the mobile phone 4 has fewer attributes than the desktop 2.

Alternatively, the use of terms a first telecommunication device 2 and a second telecommunication device 4 were avoided only for illustrative purposes in that for the most common situation of heterogeneous-type communication one user 1 at a desktop 2 would be using a desktop PC, while the second user 1 at mobile device 4 would be using a common cell phone to partake in the IM session. In general, however, the present invention can be used with any type of heterogeneous telecommunication devices.

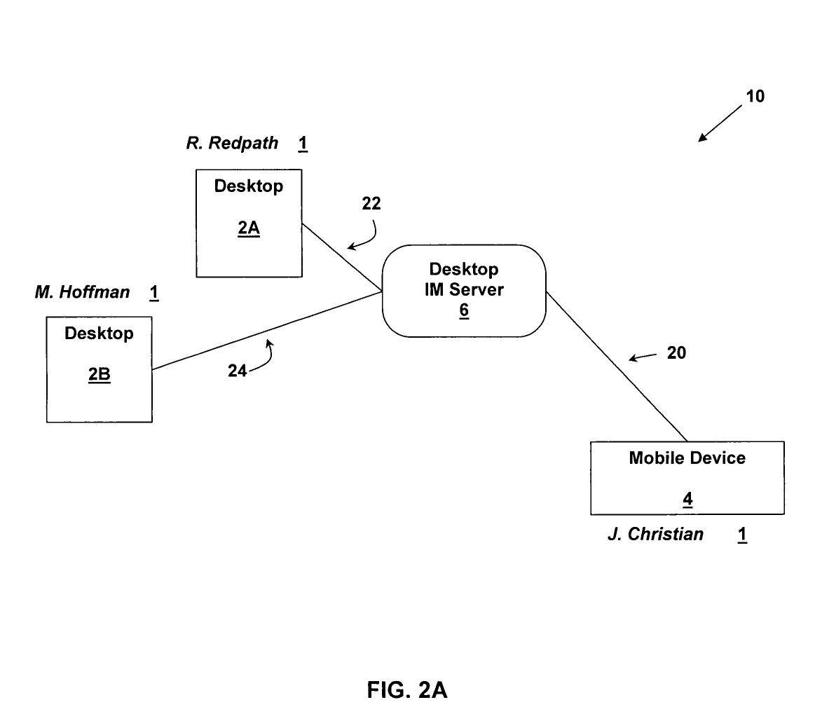

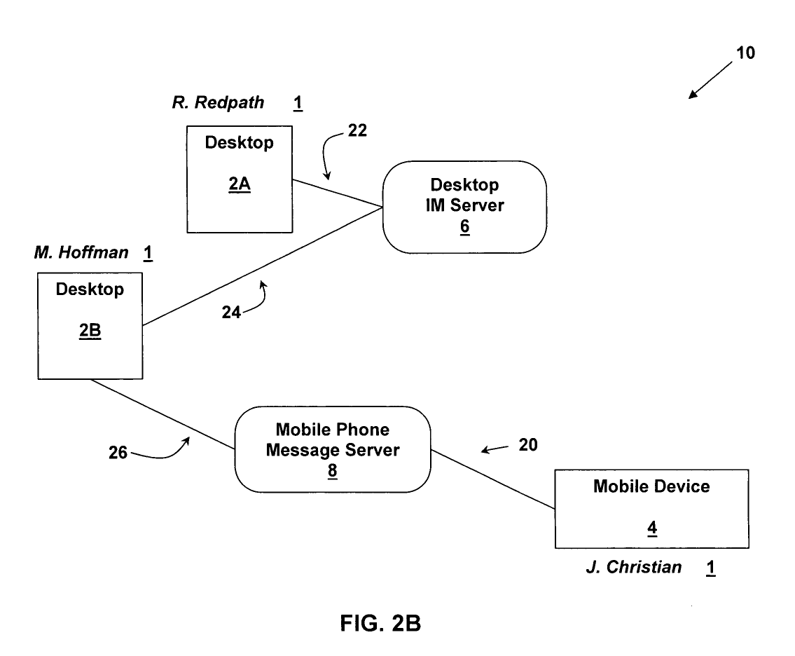

FIGS. 2A and 2B depict only two different embodiments of the network 10, wherein the present invention may be employed. In FIG. 2A, a single desktop IM server 6, located as a specific port address, handles connections and communications from mobile device 4 providers and forwards them on to other users 1 and also handles connections and communications from service Internet providers, including desktop(s) 2 (e.g., 2A, 2B) and forwards them on to other users 1. Thus, in the example shown, user 1 “R. Redpath” at desktop 2A receives and sends IM communication via a connection 22 to the desktop IM server 6; user 1 “M. Hoffman” at desktop 2B receives and sends IM communication via a connection 24 to the desktop IM server 6; and, user 1 “J. Christian” at mobile device 4 receives and sends IM communication via a connection 20 to the desktop IM server 6.

Contrastingly, the network 10 in FIG. 2B employs at least two servers 6, 8 (i.e., desktop IM server 6, mobile phone message server 8). While the desktop IM server 6 provides for IM communication via connections 22, 24 (e.g., Internet communications) to desktops 2A, 2B, a second server (i.e., mobile phone message server 8) provides for IM communication via connections 20, 26 to mobile device 4 (i.e., mobile phone communications).

The present invention provides for the reuse of a mobile Chat application on the desktop 2 of a user 1 so that the capability of the mobile device 4 is clearly and seamlessly conveyed to the user 1 at the desktop 2. Thus, a new Chat interface is created for the desktop 2 user 1.

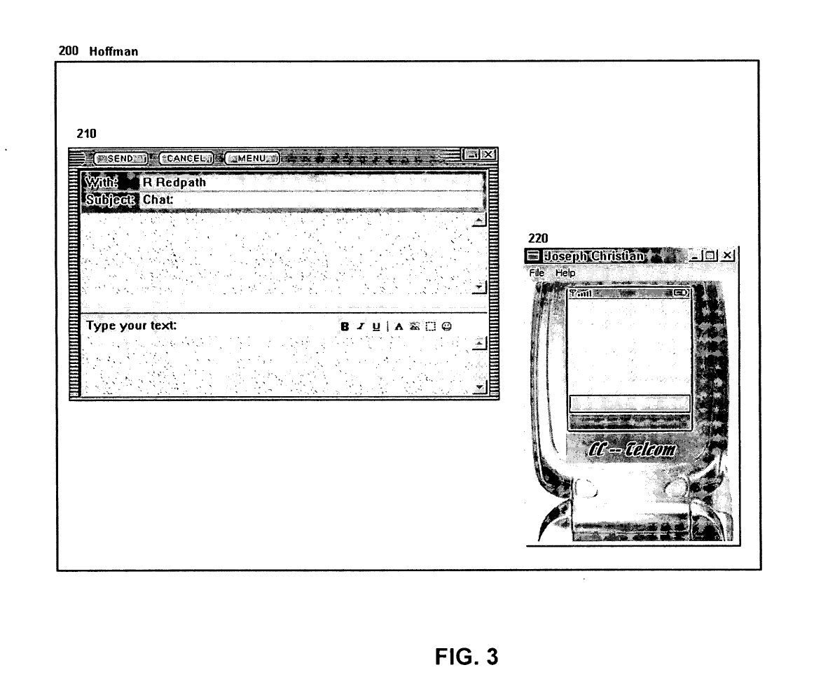

Shown in FIG. 3 is an embodiment of this new Chat interface 200, or termed “IM mobile phone for desktop” interface. In the example shown, the interface 200 is for user 1 “M. Hoffman”, wherein as discussed above, is in an IM communication session with two users 1: “J. Christian” at mobile device 4 and “R. Redpath” at desktop 2.

The interface 200 has interfaces 210, 220, or “sub” interfaces. The first interface 210, is an application communication with another desktop 4, user 1 “R. Redpath” (see FIGS. 1, 2), while the second interface 220 is an emulation for IM communication with a mobile device 4, user 1 “J. Christian” (see FIGS. 1, 2). Resultantly, user 1 (“M. Hoffman”) of interface 200 is able to readily discern that user 1 (“J. Christian”) is in IM communication via mobile device 4 and thus, can communicate accordingly (e.g., limited utility at interface 200 and desktop 2).

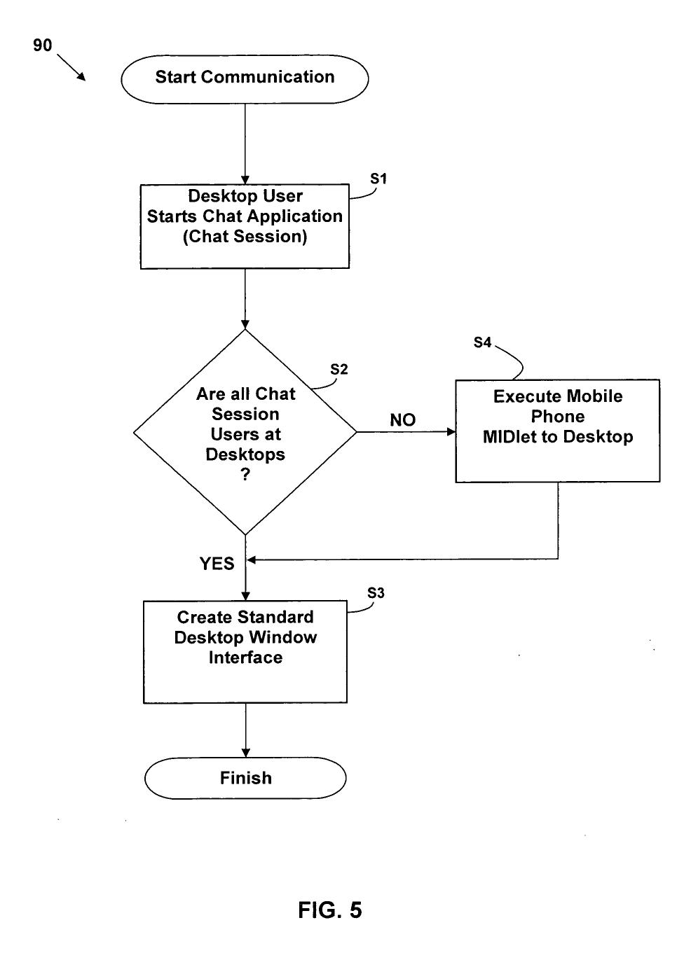

A method 90 employing an embodiment of the present invention, shown at FIG. 5, begins with a user 1 at a desktop 2, desiring to enter a Chat session, starts a Chat, or IM, application so as to allow incoming Chat sessions, or communications (step S1).

Referring to FIG. 5, upon the start of the Chat session (step S1), the Chat application is pushed by the Desktop IM server 6 (FIG. 2A) to create a Chat session between users 1. Step S2, includes a query as to whether the Chat session is with a desktop 2 user 1. If S2 is “yes” (i.e., the other user(s) 1 are all at desktop 2; there are no user(s) 1 during Chat session at a mobile device 4), then step S3 follows, wherein the Chat application creates a standard desktop window, or interface, for the Chat session to proceed as the interface 210 (see e.g., FIG. 3).

Alternatively, if the query at S2 results in “no” (i.e., at least one user 1 is at a mobile device 4), then step S4 follows wherein certain salient aspects of the present invention are applied. Specifically, a mobile phone MIDlet is reused on the desktop 2 of the user 1 so as to constrain automatically the desktop 2 user 1. Resultantly, the user interface 220 (FIG. 3) that is presented to the desktop 2 user 1 at the interface 200 makes apparent that a user 1 during the Chat session is at a mobile device 4, and may act, and react, accordingly. A MIDlet is an application, typically written in Java 2 Platform, Micro Edition version (J2ME), intended for use by a mobile device 4 that, often, complies with both Connected, Limited Device Configuration (CLDC) and Mobile Information Device Profile (MIDP). Java and all Java-based trademarks are trademarks of Sun Microsystems, Inc. in the United States, other countries, or both.

The Chat application may execute a MIDlet desktop emulator with the MIDlet code for Chat that matches closely the mobile device 4. Additionally, the user 1 can install different mobile device 4 MIDlet codes. The MIDlet emulator could be an internal Java Virtual Machine (JVM), or an external process started that is communicated from the Chat application. JVM is an interpreter that is an implementation of the Java virtual machine specification that converts Java bytecode for a hardware platform into machine language and executes it.

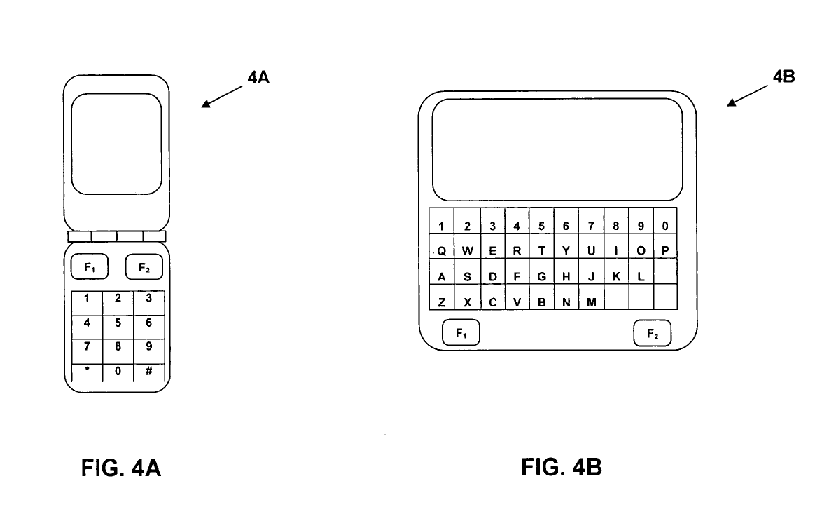

The mobile device interface 220 may be a generic looking phone (e.g., FIG. 3) that has a correct screen size to indicate a mobile phone 4 is being connected. Alternatively, brand-specific MIDlets, for actual brands, and models, of mobile devices 4 may be employed. As depicted in FIGS. 4A and 4B, MIDlet may be for a mobile device 4, such as a mobile phone 4A (FIG. 4A), or a mobile device 4, such as a PDA 4B (FIG. 4B). These may include a MIDlet from a mobile phone manufactured by Motorola, Nokia, Ericsson, and the like, and MIDlet from a PDA such as that manufactured by Blackberry™.

Mobile device 4 provides a MIDlet for the Chat application. In an embodiment, an IBM® J9 MIDlet emulator is used to run the original MIDlet that is running on the mobile device 4 on the desktop 2 when an IM connection is performed from the mobile device 4 to the desktop 2. In another embodiment, an aspect is to provide a MIDlet widget reusage of a mobile phone MIDlet on the desktop 2, thereby constraining the desktop 2 user 1 automatically.

The present invention ultimately provides a method, system, and computer program product for providing an instant messaging (IM) mobile phone interface to a desktop interface.

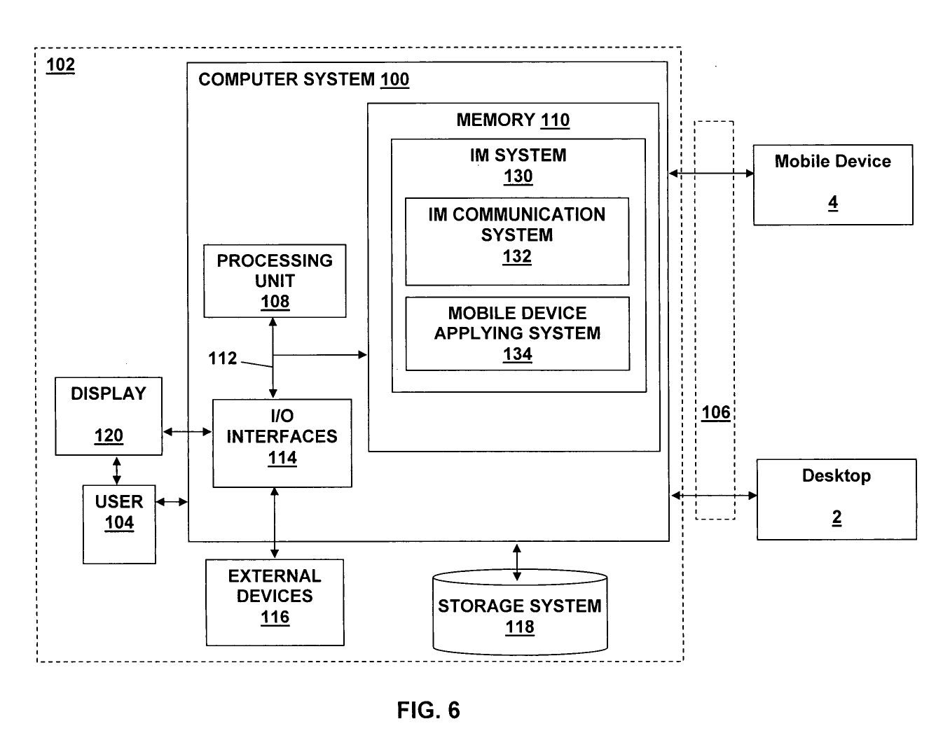

A computer system 100 for providing an instant messaging (IM) mobile phone interface to a desktop interface in accordance with an embodiment of the present invention is depicted in FIG. 6. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides a service for providing an instant messaging (IM) mobile phone interface to a desktop interface, in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as an IM System 130, which is stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 6 can be included in computer system 100. However, if computer system 100 comprises a handheld device or the like, it is understood that one or more external devices/resources 116 (e.g., display 120) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in memory 110 (e.g., as a computer program product) is an Instant Messaging (IM) System 130 for providing an IM mobile phone interface to a desktop interface, in accordance with embodiment(s) of the present invention. The IM System 130 generally includes a IM Communication System 132 for providing IM communication between a desktop 2 and a mobile device 4, as described above. The IM System 130 generally includes a Mobile Device Applying System 134 for using a mobile device 4 IM application on the desktop 2, as described above.

The present invention can be offered as a business method on a subscription or fee basis. For example, one or more components of the present invention can be created, maintained, supported, and/or deployed by a service provider that offers the functions described herein for customers. That is, a service provider can be used to provide an instant messaging (IM) mobile phone interface to a desktop interface, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk-read only disk (CD-ROM), a compact disk-read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method of providing an instant messaging (IM) mobile phone interface to a desktop interface comprising:
providing an IM communication between a desktop and a mobile device; and
using a mobile device IM application on the desktop.

2. The method of claim 1, the IM application being a MIDlet.

3. The method of claim 1, the using further comprising emulating a user interface of the mobile device.

4. The method of claim 1, the using further comprising reusing a MIDlet of the mobile device.

5. The method of claim 1, the mobile device IM application matches an IM application used by the mobile device.

6. The method of claim 1, the providing further comprising starting an IM application on the desktop.

7. The method of claim 1, further comprising:
constraining a functionality of the desktop.

8. A system for providing an instant messaging (IM) mobile phone interface to a desktop interface comprising:
a system for IM communication between a desktop and a mobile device; and
a system for using a mobile device IM application on the desktop.

9. The system of claim 8, the IM application being a MIDlet.

10. The system of claim 8, the using system further comprising a system for emulating a user interface of the mobile device.

11. The system of claim 8, the using system further comprising a system for reusing a MIDlet of the mobile device.

12. The system of claim 8, wherein the mobile device IM application matches an IM application used by the mobile device.

13. The system of claim 8, the IM communication system further comprising a system for starting an IM application on the desktop.

14. The system of claim 8, further comprising:
a system for constraining a functionality of the desktop.

15. A program product stored on a computer readable medium for providing an instant messaging (IM) mobile phone interface to a desktop interface, the computer readable medium comprising program code configured to:
provide an IM communication between a desktop and a mobile device; and
use a mobile device IM application on the desktop.
